(19) United States
(12) Patent Application Publication
(10) Pub. No.: US 2007/0073602 A1
(43) Pub. Date: Mar. 29, 2007

(54) Method, system, and program product for conditional rule-based billing with real-time error checking and for on-demand segmented labor recovery and reporting

(75) Inventors: Scott D. Hicks, Underhill Center, VT (US); Rachele S. Kurtz, Cary, NC (US); Victoria A. Locke, Newburgn, NY (US); James A. Martin JR., Endicott, NY (US); Douglas G. Murray, Johnson City, NY (US); Linda H. Stelljes, Sullivans Island, SC (US); Jerry A. Thomas, Delray Beach, FL (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/230,958

(22) Filed: Sep. 20, 2005

(51) Int. Cl. A01K 5/02; G06F 17/50

(52) U.S. Cl. 705/29

(57) ABSTRACT

The present invention provides a method, system, and computer program product for conditional rule-based billing with real-time error checking and for on-demand segmented labor recovery and reporting. A method in accordance with an embodiment of the present invention includes: providing a record in a database for a device to be serviced; providing a record in the database for a customer associated with the device to be serviced; updating the record of the device in response to a servicing of the device, wherein the record for the serviced device is updated to reflect: materials and labor required for the servicing of the device; an indication of a completion of the servicing; and a completion date of the servicing; determining if all of a predetermined set of conditions required for proper billing have been met, upon completion of the servicing of the device; and billing for the servicing of the device only if all of the predetermined set of conditions have been met.

### BACKGROUND OF THE INVENTION

1. Field of the Invention

The present invention generally relates to computerized billing systems. More particularly, the present invention provides a method, system, and computer program product for conditional rule-based billing with real-time error checking and for on-demand segmented labor recovery and reporting.

2. Related Art

Information Technology (IT) projects that provide services to individual employees may need to bill those employees' business units for materials or labor. The materials or labor can vary between employees, depending upon the individual employee's existing hardware or software configuration, environmental conditions, network connection, requirements for system modifications or system capabilities, etc. For example, during a migration from a token ring to an Ethernet network:
(A) There may be different types of Ethernet adapters required for different types of workstations;
(B) Some employees may need patch cables;
(C) Some employees may need specialized connectors to plug a cable into a particular type of wall port; and
(D) The time needed to migrate each system may vary depending upon the system's hardware and software configuration.

There can also exist a requirement to bill different business units at different organizational levels (e.g., an employee's department, project overhead, a grouping of departments, a division, a grouping of divisions, etc.). Reports need to be provided to the business units to justify the billing, including details of materials or labor provided.

Initiating the billing may require that certain conditions be met, such as:
(A) Verifying the employee's name or serial number against a corporate directory;
(B) Obtaining the employee's department and division information;
(C) Properly recording which materials were used on a particular system;
(D) Recording who supplied each of the material types—if the employee supplied the material, they should not be billed;
(E) Recording how much labor was used for various tasks during the migration;
(F) Recording the date that the services were provided; and
(G) Recording completion of the services for that employee.

Known solutions to this problem require billing in aggregate. Such solutions can only provide conditional billing by using a labor intensive paper process (e.g., filling out a paper form for every employee or device that received service). If there is missing or erroneous data, this would only be discovered at the time that the data from the forms is entered into the billing system. Unfortunately, the individuals who provided the service are usually not available to provide verification or fill in the missing data.

In addition to the above, there does not exist a method and tools to record, report, and recover labor for a service project, which differentiates between categories of labor and automatically reports and bills the labor dependent upon the categorization. That is, labor often needs to be reported and billed in different ways for different organizations, and for different categories of labor. Without an automated system, it is not practical to satisfy this type of segmented billing, especially when dealing with large service projects involving hundreds or even thousands of systems.

### SUMMARY OF THE INVENTION

In general, the present invention provides a method, system, and computer program product for conditional rule-based billing with real-time error checking and for on-demand segmented labor recovery and reporting. In particular, the present invention, provides project billing only when a series of conditions have been met, provides real-time error checking, and can bill different business units at different levels.

A record is created in a database for each device or employee that receives a project's service. When the service is provided, the records are updated to record:
(A) The materials and/or labor provided;
(B) The fact that the service was completed; and
(C) The date that the service was completed.
   When the record is marked as “complete,” the tool checks to make sure that all necessary conditions have been met for proper billing. If any of these conditions are not met, the tool prompts the user to provide or correct the information.

A representative from each business unit indicates the preferred level of billing for their business unit (e.g., department, project overhead, a grouping of departments, a division, a grouping of divisions, etc.). The preferred level of billing for a business unit may also be provided automatically (e.g., based on client requirements). This information is configured in the database. When the billing processing occurs, the database compiles the billing records at the requested organizational level for each business unit. Periodic reports can be generated for each business unit to justify the billing and provide the requested level of detail to show how the billed amounts were calculated.

An automated system is provided to record, report, and recover labor costs for a service project, differentiating between categories of labor and automatically reporting and billing labor dependent upon the categorization. The system includes a data collection tool to capture labor values in the field in real time, and an electronic database to gather, bill, and report the labor values for the entire project.

A first aspect of the present invention is directed to a method for conditional rule-based billing for a servicing project, comprising: providing a record in a database for a device to be serviced; providing a record in the database for a customer associated with the device to be serviced; updating the record of the device in response to a servicing of the device, wherein the record for the serviced device is updated to reflect: materials and labor required for the servicing of the device; an indication of a completion of the servicing; and a completion date of the servicing; determining if all of a predetermined set of conditions required for proper billing have been met, upon completion of the servicing of the device; and billing for the servicing of the device only if all of the predetermined set of conditions have been met.

A second aspect of the present invention is directed to a system for conditional rule-based billing for a servicing project, comprising: a system for providing a record in a database for a device to be serviced; a system for providing a record in the database for a customer associated with the device to be serviced; a system for updating the record of the device in response to a servicing of the device, wherein the record for the serviced device is updated to reflect: materials and labor required for the servicing of the device; an indication of a completion of the servicing; and a completion date of the servicing; a system for determining if all of a predetermined set of conditions required for proper billing have been met, upon completion of the servicing of the device; and a system for billing for the servicing of the device only if all of the predetermined set of conditions have been met.

A third aspect of the present invention is directed to a program product stored on a computer readable medium for conditional rule-based billing for a servicing project, the computer readable medium comprising program code for performing the following steps: providing a record in a database for a device to be serviced; providing a record in the database for a customer associated with the device to be serviced; updating the record of the device in response to a servicing of the device, wherein the record for the serviced device is updated to reflect: materials and labor required for the servicing of the device; an indication of a completion of the servicing; and a completion date of the servicing; determining if all of a predetermined set of conditions required for proper billing have been met, upon completion of the servicing of the device; and billing for the servicing of the device only if all of the predetermined set of conditions have been met.

A fourth aspect of the present invention is directed to a method for deploying an application for conditional rule-based billing for a servicing project, comprising: providing a computer infrastructure being operable to: provide a record in a database for a device to be serviced; provide a record in the database for a customer associated with the device to be serviced; update the record of the device in response to a servicing of the device, wherein the record for the serviced device is updated to reflect: materials and labor required for the servicing of the device; an indication of a completion of the servicing; and a completion date of the servicing; determine if all of a predetermined set of conditions required for proper billing have been met, upon completion of the servicing of the device; and bill for the servicing of the device only if all of the predetermined set of conditions have been met.

A fifth aspect of the present invention provides computer software embodied in a propagated signal for conditional rule-based billing for a servicing project, the computer software comprising instructions to cause a computer system to perform the following functions: provide a record in a database for a device to be serviced; provide a record in the database for a customer associated with the device to be serviced; update the record of the device in response to a servicing of the device, wherein the record for the serviced device is updated to reflect: materials and labor required for the servicing of the device; an indication of a completion of the servicing; and a completion date of the servicing; determine if all of a predetermined set of conditions required for proper billing have been met, upon completion of the servicing of the device; and bill for the servicing of the device only if all of the predetermined set of conditions have been met.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a database containing device and customer records and the updating of device records in response to servicing.

FIG. 2 depicts the updating of a device record in greater detail.

FIG. 3 depicts a billing process in accordance with an embodiment of the present invention.

FIG. 4 depicts an illustrative interface for entering data associated with the servicing of a device.

FIG. 5 depicts an example of segmented billing and reporting provided by the present invention for a plurality of business units for a plurality of labor categories.

FIGS. 6-8 depict examples of reports generated in accordance with an embodiment of the present invention.

FIG. 9 illustrates a system for implementing an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, and computer program product for conditional rule-based billing with real-time error checking and for on-demand segmented labor recovery and reporting.

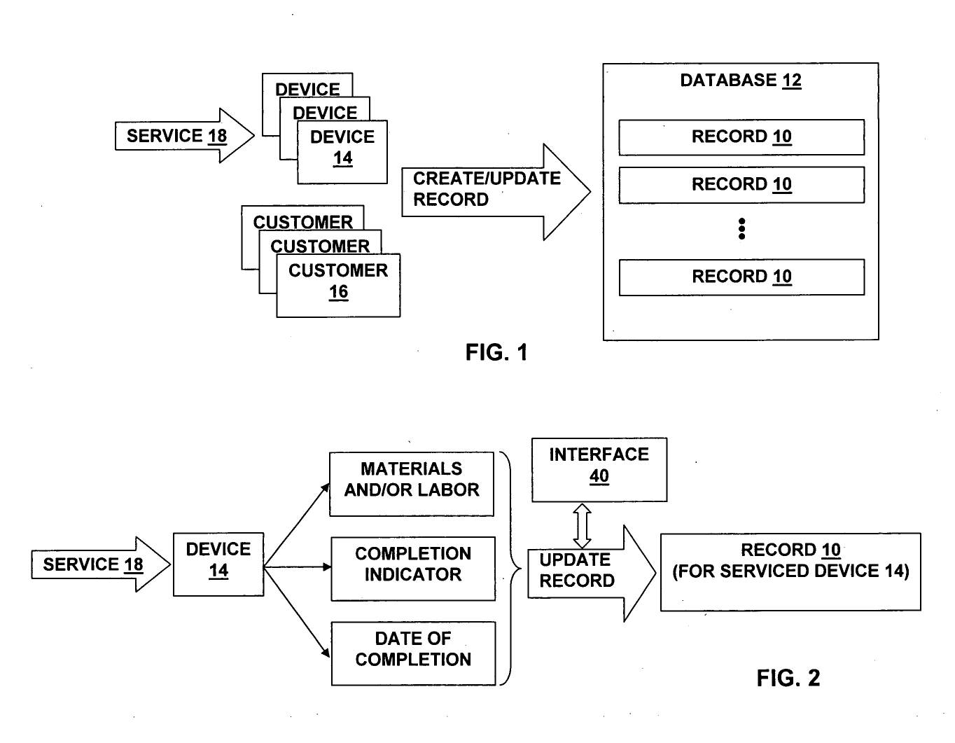

As shown in FIG. 1, a record 10 is created/updated in a database 12 for each device 14 (e.g., computer, peripheral, etc.) that is to receive or has received a service 18 and each customer 16 (e.g., owner or user of a device 14). In the following description, the service 18 is described in terms of an IT migration of devices 14 within a company from a first type of network (e.g., token ring) to a second type of network (e.g., Ethernet). As such, each device 14 corresponds to a computer, printer, or other peripheral connected to the network and each customer 16 corresponds to an employee of the company. It should be realized, however, that the concepts of the present invention can be used in conjunction with many other types of billable services/activities without departing from the intended scope of the present invention.

The service 18 may include, for example, removing old network adapters, installing new network adapters, removing/installing/updating drivers, removing/installing/updating workstations, removing/installing/updating telephones, installing/updating software, providing and installing new network cables, etc. The record 10 corresponding to each device 14 may include, for example, a device identifier such as a serial number, the name or employee number of the employee associated with the device 14, the system/software configuration of the device 14, etc. The record 10 corresponding to each customer 16 may include, for example, the customer's name, employee number, department name, etc. Such customer information is used to determine who should be billed for a service 18 performed on a device 14.

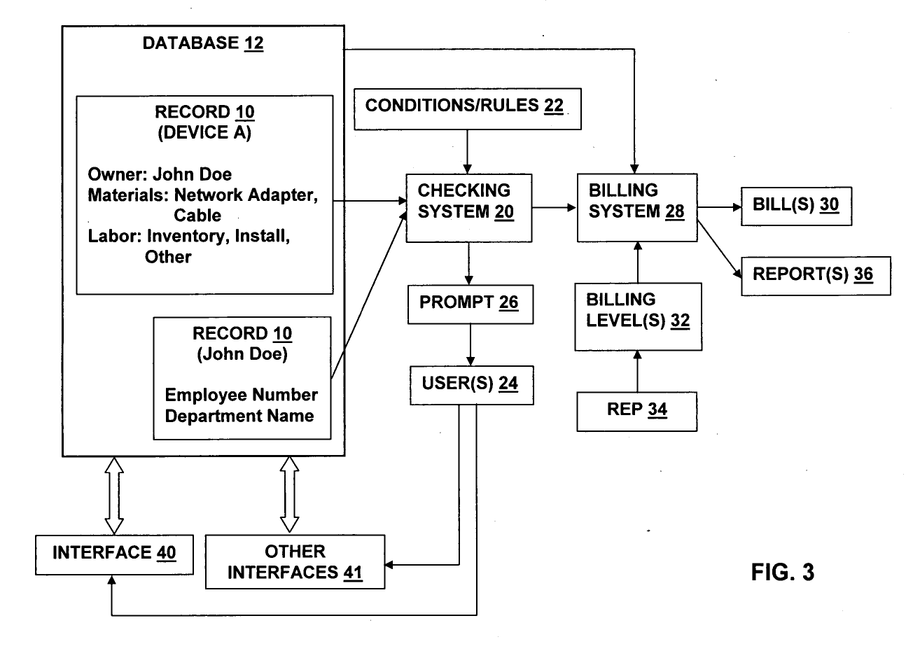

As depicted in FIG. 2, when a service 18 is performed on a device 14, the record 10 corresponding to the device 14 stored in database 12 is updated (e.g., via interface 40) to reflect:
(A) The materials (e.g., network adapters, cables, specialized connectors, etc.) and/or labor (e.g., actual time, planned time, etc.) provided;
(B) An indication that the service 18 was completed; and
(C) The date that the service 18 was completed.
   When a record 10 is marked as “complete,” the present invention checks to make sure that all necessary conditions have been met for proper billing. Such conditions may include, for example:
(A) Verifying the name or employee number of the customer 16 against a directory (e.g., a corporate directory);
(B) Obtaining department and division information for the customer 16;
(C) Properly recording which materials were required during the servicing of a particular device 14;
(D) Recording who supplied each of the materials—if the customer 16 supplied the material, they should not be billed;
(E) Recording how much labor was used for various tasks during the servicing;
   (E.1) Recording the identity of the technician who provided the service so that the proper billing rate can be utilized.
(F) Recording the date(s) that the service 18 was provided; and
(G) Recording completion of the service 18 for the customer 16.
   If any of these conditions are not met, the present invention prompts the user who entered the data (e.g., the technician who performed the service 18) to provide and/or correct the required information. The error checking for the conditional billing can be performed in the database 12, or in a separate executable program that is used to capture data in the field at the time that the service 18 is provided.

The present invention allows the level of billing to be specified. For example, a representative from each business unit in a company can indicate the preferred level of billing for their business unit. The preferred level of billing for a business unit may also be provided automatically (e.g., based on client requirements). This information is configured in the database 12. When the billing processing occurs, the database 12 compiles billing records at the requested level (e.g., organizational level for each business unit) and corresponding bills are generated. Periodic reports can be also generated (e.g., for each business unit) to justify the billing and provide a requested level of detail to show how the billed amounts were calculated. The periodic reports can be generated weekly, bi-weekly, monthly, yearly, etc. Reports can also be generated on-demand.

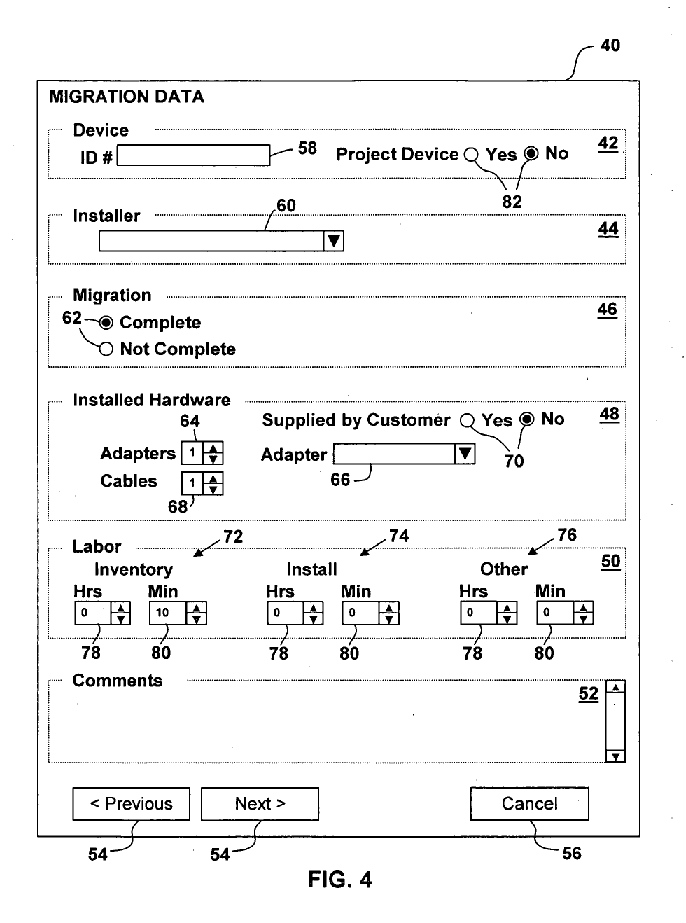

The above-described process is depicted in greater detail in FIG. 3. In this example, it is assumed that a plurality of devices 14 belonging to a business unit have been migrated from one type of network to another. The records 10 in database 12 for a device 14, “Device A,” associated with a customer 16, “John Doe,” are shown. In accordance with the present invention, the record 10 corresponding to each migrated device 14 is updated (e.g., via interface 40 of a data collection tool) to reflect the materials (e.g., a new network adapter and cable) and labor (e.g., time required to inventory device 14, time required to install required materials, other time associated with the migration, etc.) required for the migration.

Prior to billing for the migration services, a checking system 20 examines the records 10 to ensure that all necessary conditions/rules 22 have been met for proper billing. If all of the conditions/rules 22 have not been met, the user(s) 24 responsible for entering the migration data is/are prompted 26 to provide/correct the missing/incorrect information (e.g., via interface 40 and/or other provided interfaces 41). This checking process is repeated until all necessary conditions/rules 22 have been met for proper billing.

After the checking system 20 has determined that all necessary conditions/rules 22 have been met, a billing system 28 (which may be provided as part of database 12) is used to generate one or more bills 30 for the migration based on one or more specified levels of billing 32 (e.g., department, division, corporate, project overhead, etc.). A level of billing 32 can be set, for example, by a representative 34 of the business unit which owns or is responsible for the migrated devices 14. The billing system 32 also generates reports 36 (e.g., for each business unit) that can be used to justify the billing and provide a requested level of detail to show how the billed amounts were calculated.

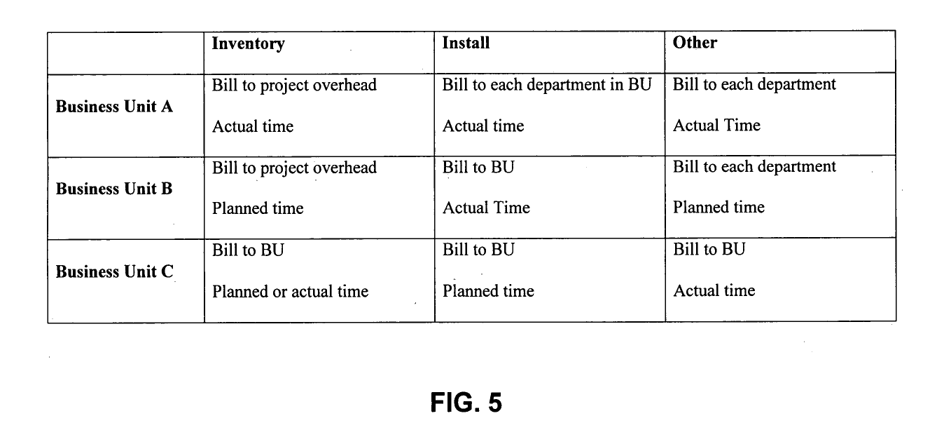

An illustrative interface 40 of a data collection tool for entering data associated with the migration of a device 14 is depicted in FIG. 4. The interface 40 includes a device ID section 42, an installer section 44, a migration section 46, an installed hardware section 48, a labor section 50, and a comments section 52. Conventional navigation buttons 54 and a cancel button 56 are also provided. Data can be entered into the interface 40 by the technician who performs/performed the migration of the device 14 (allowing labor values to be captured in real time) or by other authorized personnel.

The identity of the device 14 for which data is/has being entered is inserted into a device field 58 in the device ID section 42 of the interface 40. The serial number or other identifier of the device can be used. The identity of the technician responsible for the migration of the device 14 is entered into the installer name field 60 in the installer section 44. The technician's identity can be selected using a drop-down menu as shown, or can be entered using any other suitable method. The status of the migration, e.g., “Complete,” or “Not Complete” is provided (e.g. using radio buttons 62 or other suitable technique) in the migration section 46.

The number and type of network adapters installed into the device 14 for the migration are provided in an adapter count field 64 and an adapter type field 66, respectively, in the installed hardware section 48 of the interface 40. The number of required network cables is entered into a cable count field 68. The number of network adapters and cables can be incremented/decremented as necessary using, for example, up/down buttons as shown or using any other suitable technique (e.g., direct entry). The type of network adapter can be selected using a drop-down menu as shown, or can be entered using any other suitable method. Fields for entering the number and/or type of additional hardware used in the migration of the device 14 can also be provided. The supplier of the hardware used in the migration of the device 14 is indicated, for example, using radio buttons 70; if the customer supplied the hardware, then the customer will not be billed for the hardware—otherwise the customer will be billed.

The labor section 50 of the interface 40 includes three subsections: inventory 72; install 74; and “other” 76. The time required to determine a system inventory of the device 14 prior to migration is entered into the inventory subsection 72. Such an inventory is used to determine, for example, the hardware and software configuration of the device 14 prior to migration and the hardware/software that is needed to perform the migration. The time required to perform the actual migration is entered in the install subsection 74. The installation time may comprise, for example, the time required to remove the currently installed network adapter, driver, and cable, and the time required to install a new network card, driver, and cable. Other miscellaneous time (e.g., break/fix) related to the migration process not entered into the inventory and install subsections 72, 74 is entered in the “other” subsection 76.

Each subsection 72, 74, and 76 of the labor section 50 of the interface 40 includes an hour field 78 and a minute field 80. Time can be entered into the hour and minute fields 78, 80 using incrementing/decrementing buttons as shown, or can be entered directly into the fields. Other techniques for entering the time can also be used. The time entered in each subsection 72, 74, and 76 of the labor section 50 may comprise the actual time expended to perform the associated task(s), or may comprise a pre-configured planned (i.e., default) time that is entered automatically. A planned time may comprise, for example, an estimate of the time it should take to perform the task(s), the average time required to perform the task(s), the time corresponding to a fixed-fee set by the customer 16, or another pre-approved/configured time value. As shown in the inventory subsection 72 of the labor section 50, for example, a planned time of 10 minutes has automatically been entered into the minute field 80. If desired, a planned time can be overridden by entering an actual time into the corresponding hour and/or minute field 78, 80.

If a device 14 is associated with the migration process itself, then the material/labor costs of migrating that device 14 can be applied to the overhead of the migration project, instead of being billed to a customer 16. Such a device 14 may comprise, for example, a computer used to enter migration data into a database or a printer used to print billing reports. The costs of migrating computers and network ports in public areas such as conference rooms and the cost of public shared printers can also be applied to the overhead of the migration project. The device 14 can be identified as being associated with the migration project using the information entered into the device field 58 in the device ID section 42 of the interface 40. Alternatively, a technician can explicitly identify the device 14 as being associated with the migration project via the interface 40 (e.g., using radio buttons 82).

The present invention provides an automated system for recording, reporting, and recovering labor costs for a service (e.g., migration) project, which is capable of differentiating between categories of labor and automatically reporting and billing labor dependent upon the categorization. Labor values are captured in a data collection tool (via interface 40) in the field in real time and a billing system 28 (e.g., provided by database 12) is used to gather, bill, and report the labor values for the entire service project.

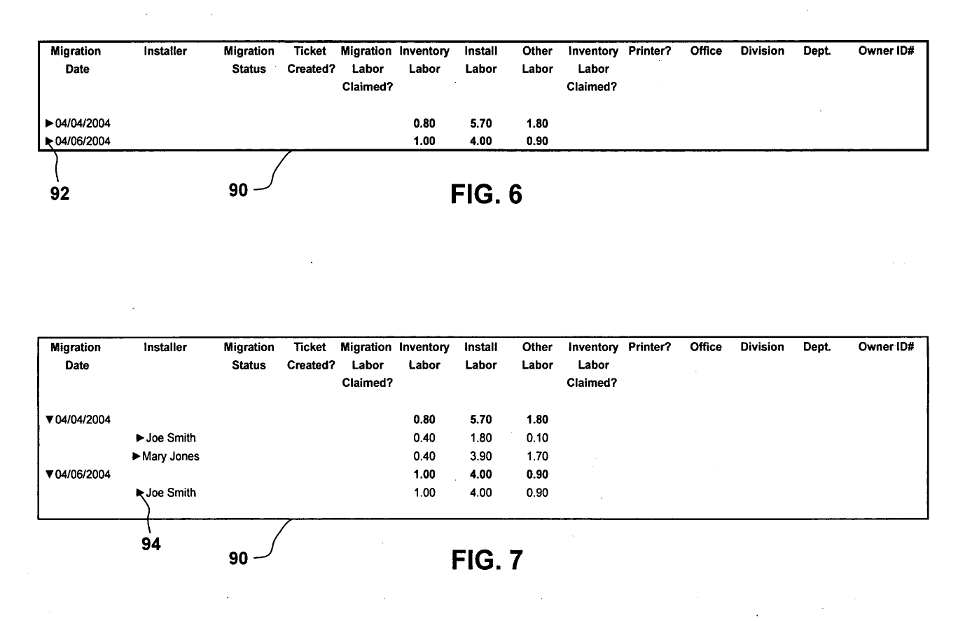

Examples of the segmented billing and reporting provided by the present invention for a plurality of business units (i.e., Business Unit A, Business Unit B, and Business Unit C) for a plurality of labor categories (e.g., Inventory, Install, and Other) are depicted in FIG. 5. For example, labor categorized as inventory (see, interface 40, FIG. 4) and associated with Business Unit A is billed to project overhead as actual time, labor categorized as install and associated with Business Unit C is billed to Business Unit C as planned time, while labor billed as “other” and associated with Business Unit B is billed to each department at planned time. Note that not all possible combinations are illustrated.

As detailed above, labor times can be recorded using interface 40 in the field by each technician for each category of labor (e.g., inventory, install, and “other”). If labor will be billed at a planned rate, then a default value can be pre-filled in the appropriate hour and minute fields 78, 80 in the labor section 50 of interface 40. If labor will be billed at the actual time expended, then the technician records the actual time. Alternatively, the technician can record their time and then enter it into the database directly at the end of the day. Default values (e.g., for billing at planned rates) can be pre-configured, for example, by editing a text file.

The recorded labor values can be summarized and displayed by the database 12 in customized views tailored for the needs of each team member. For example: technicians can see their own labor summarized by activity category, by customer group, and by time period (e.g., day, week, or month). Team leaders can see the labor of their team summarized by activity category, by customer group, by time period, by type of device migrated, by operating system, by hardware installed, etc. Project Managers can see labor for the entire project summarized as described above, or compared to planned values from the project budget. The labor can be summarized by sub-project, by building, by floor, by network closet, etc. The technicians can then use this summarized information to feed other billing and reporting systems as needed, either automatically after verification, or manually.

Project managers can generate bills at the project level for the customer organizations. The database 12 can be pre-configured to aggregate the labor and bill it according to the method requested by each business unit. The billing can occur through an interface to existing billing systems if needed.

Project managers can use the database to generate labor billing reports tailored to the demands of each business unit. Pre-set views can be provided by database 12 for this purpose. Knowledgeable project managers can also design their own customized views in the database 12. Project managers or team leaders can use the summarized data to refine plans for the remainder of the project or to plan future projects.

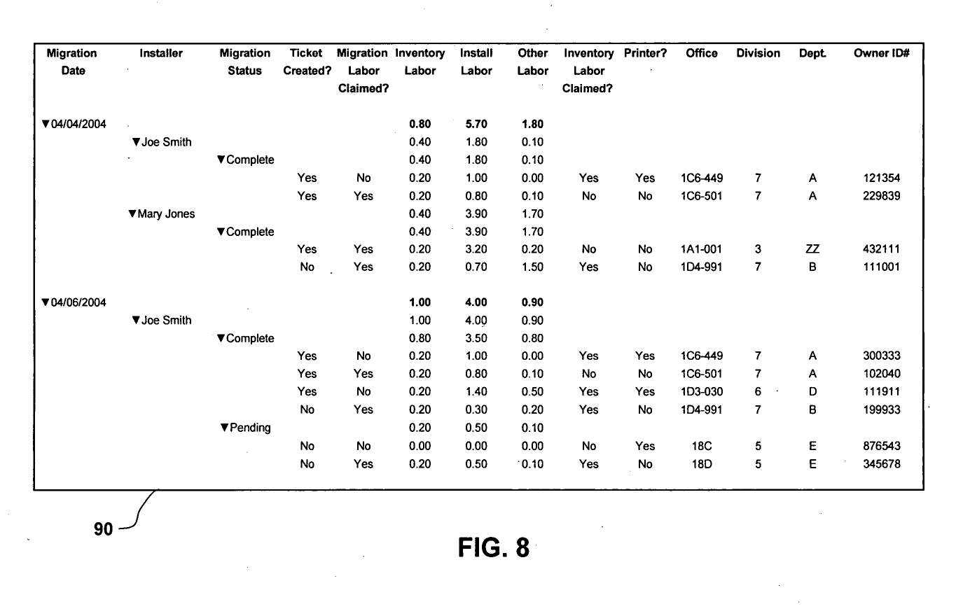

An example of a report 90 that can be generated in accordance with the present invention is depicted in FIGS. 6-8. As shown, report 90 provides a daily summary of the labor performed by a pre-defined set of technicians performing migration services. In a first view (FIG. 6), the total labor is summarized by date. As shown, the total amount of inventory, install, and other labor performed by all technicians on Apr. 4, 2004 was 0.80 hours, 5.7 hours, and 1.80 hours, respectively. In a second view (FIG. 7), the report 90 has been expanded to show the total labor by technician by date (e.g., by clicking on the arrows 92 in FIG. 6). As shown, on Apr. 4, 2004, for example, technician Joe Smith performed a total of 0.40 hours of inventory labor, 1.80 hours of install labor, and 0.10 hours of other labor, while technician Mary Jones performed a total of 0.40 hours of inventory labor, 3.90 hours of install labor, and 1.7 hours of other labor. In a third view (FIG. 8), the report 90 has been further expanded (e.g., by clicking on the arrows 94 in FIG. 7) to show specific details of the daily migration activities performed by each technician. Many other types of reports can also be generated using the data that has been entered/stored (e.g., via interface 40) in database 12.

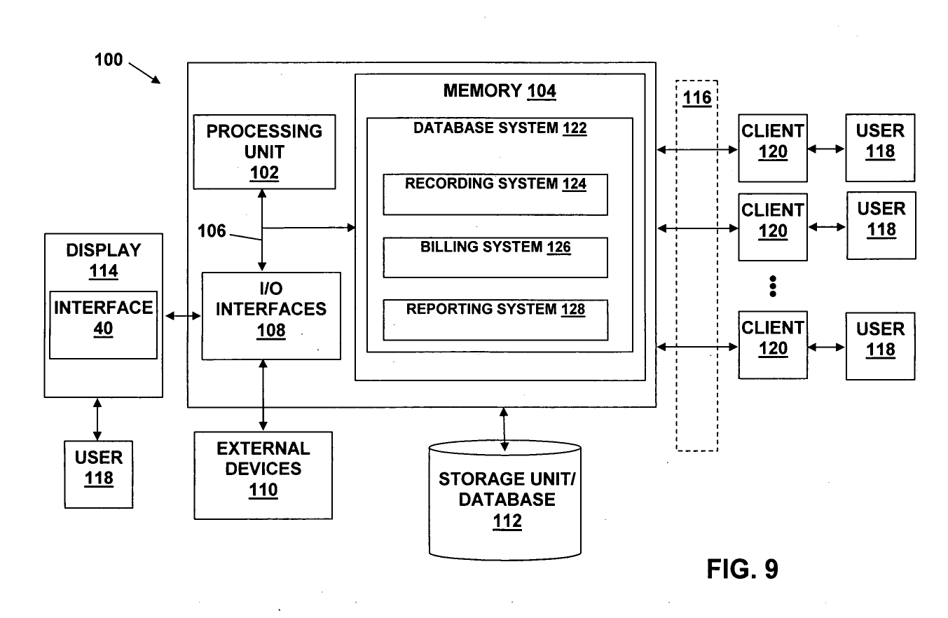

A computer system 100 for implementing an embodiment of the present invention is illustrated in FIG. 9. As shown, computer system 100 generally includes a processing unit 102, memory 104, bus 106, input/output (1/0) interfaces 108, external devices/resources 110, and storage unit/database 112 (e.g., database 12). Processing unit 102 may comprise a single processing unit, or may be distributed across one or more processing units in one or more locations. Memory 104 may comprise any known type of data storage and/or transmission media, including magnetic media, optical media, random access memory (RAM), read-only memory (ROM), etc. Moreover, similar to processing unit 102, memory 104 may reside at a single physical location, comprising one or more types of data storage, or be distributed across a plurality of physical systems in various forms.

I/O interfaces 108 may comprise any system for exchanging information to/from an external source. External devices/resources 110 may comprise any known type of external device, including speakers, a CRT, LED screen, handheld device, keyboard, mouse, voice recognition system, speech output system, printer, monitor/display (e.g. display 114), facsimile, pager, etc.

Bus 106 provides a communication link between each of the components in computer system 100, and likewise may comprise any known type of transmission link, including electrical, optical, wireless, etc. In addition, although not shown, additional components, such as cache memory, communication systems, system software, etc., may be incorporated into computer system 100.

Data used in the practice of the present invention can be stored locally to computer system 100, for example, in storage unit/database 112, and/or may be provided to computer system 100 over a network 116. Storage unit/database 112 can be any system capable of providing storage for data and information under the present invention. As such, storage unit/database 112 may reside at a single physical location, comprising one or more types of data storage, or may be distributed across a plurality of physical systems in various forms. In another embodiment, storage unit/database 112 may be distributed across, for example, a local area network (LAN), wide area network (WAN) or a storage area network (SAN) (not shown).

Network 116 is intended to represent any type of network over which data can be transmitted. For example, network 116 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

Users 118 (e.g., technicians) can access computer system 100 directly or via one or more clients 120 connected to computer system 100 over network 116. Each client 120 comprises components similar to those present in computer system 100. Each user 118 can enter data into computer system 100 via one or more interfaces (e.g., interface 40).

Shown in memory 104 as a computer program product is a database system 122. Database system 122 includes a recording system 124 with error checking for providing/updating records in storage unit/database 112 (e.g., based on data entered by a user via interface 40), a billing system 126 for billing records at requested levels in accordance with the present invention, and a reporting system 128 for generating reports in accordance with the present invention.

It should be appreciated that the teachings of the present invention can be offered as a business method on a subscription or fee basis. For example, one or more components of the present invention could be created, maintained, supported, and/or deployed by a service provider that offers the functions described herein for customers. That is, a service provider could be used to provide conditional rule-based billing with real-time error checking and on-demand segmented labor recovery and reporting, as described above.

It should also be understood that the present invention can be realized in hardware, software, a propagated signal, or any combination thereof. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for conditional rule-based billing for a servicing project, comprising:
providing a record in a database for a device to be serviced;
providing a record in the database for a customer associated with the device to be serviced;
updating the record of the device in response to a servicing of the device, wherein the record for the serviced device is updated to reflect:
materials and labor required for the servicing of the device;
an indication of a completion of the servicing; and
a completion date of the servicing;
determining if all of a predetermined set of conditions required for proper billing have been met, upon completion of the servicing of the device; and
billing for the servicing of the device only if all of the predetermined set of conditions have been met.

2. The method of claim 1, wherein the servicing project comprises a migration of the device from a first type of network to a second type of network.

3. The method of claim 1, wherein the predetermined set of conditions comprises:
verifying a name of the customer;
obtaining organizational information for the customer;
recording which materials were required during the servicing of the device;
recording who supplied the materials required during the servicing of the device;
recording how much labor was required for various tasks performed during the servicing;
recording a date of the servicing of the device; and
recording completion of the servicing of the device.

4. The method of claim 1, wherein the billing step further comprises:
billing at one or more specified levels of billing.

5. The method of claim 1, further comprising:
differentiating between different categories of labor; and
reporting and billing the labor based upon the categorization.

6. The method of claim 5, wherein the categories of labor comprise inventory, install, and other.

7. The method of claim 5, wherein the labor is billed using at least one of:
actual expended time; and
a planned time.

8. The method of claim 1, further comprising:
providing an interface for providing data associated with the servicing of the device.

9. Deploying an application for conditional rule-based billing, comprising:
providing a computer infrastructure being operable to perform the method of claim 1.

10. Computer software embodied in a propagated signal for conditional rule-based billing, the computer software comprising instructions to cause a computer system to perform the method of claim 1.

11. A system for conditional rule-based billing for a servicing project, comprising:
a system for providing a record in a database for a device to be serviced;
a system for providing a record in the database for a customer associated with the device to be serviced;
a system for updating the record of the device in response to a servicing of the device, wherein the record for the serviced device is updated to reflect:
materials and labor required for the servicing of the device;
an indication of a completion of the servicing; and
a completion date of the servicing;
a system for determining if all of a predetermined set of conditions required for proper billing have been met, upon completion of the servicing of the device; and
a system for billing for the servicing of the device only if all of the predetermined set of conditions have been met.

12. The system of claim 11, wherein the servicing project comprises a migration of the device from a first type of network to a second type of network.

13. The system of claim 11, wherein the system for determining if all of the predetermined set of conditions required for proper billing have been met is configured to:
verify a name of the customer;
obtain organizational information for the customer;
record which materials were required during the servicing of the device;
record who supplied the materials required during the servicing of the device;
record how much labor was required for various tasks performed during the servicing;
record a date of the servicing of the device; and
record completion of the servicing of the device.

14. The system of claim 11, wherein the system for billing further comprises:
a system for billing at one or more specified levels of billing.

15. The system of claim 11, further comprising:
a system for differentiating between different categories of labor; and
a system for reporting and billing the labor based upon the categorization.

16. The system of claim 15, wherein the categories of labor comprise inventory, install, and other.

17. The system of claim 15, wherein the labor is billed using at least one of:
actual expended time; and
a planned time.

18. The system of claim 11, further comprising:
a system for providing an interface for providing data associated with the servicing of the device.

19. A program product stored on a computer readable medium for conditional rule-based billing for a servicing project, the computer readable medium comprising program code for performing the following steps:
providing a record in a database for a device to be serviced;
providing a record in the database for a customer associated with the device to be serviced;
updating the record of the device in response to a servicing of the device, wherein the record for the serviced device is updated to reflect:
materials and labor required for the servicing of the device;
an indication of a completion of the servicing; and
a completion date of the servicing;
determining if all of a predetermined set of conditions required for proper billing have been met, upon completion of the servicing of the device; and
billing for the servicing of the device only if all of the predetermined set of conditions have been met.
